(19) United States
(12) Patent Application Publication
(10) Pub. No.: US 2026/0005499 A1
(43) Pub. Date: Jan. 1, 2026

(54) METHOD AND KIT FOR FLUSH MOUNTING OF SWITCHES AND SOCKETS IN BOARD MATERIAL

(71) Applicant: SHIVER NV, Veurne (BE)

(72) Inventor: Thibault RENSON, Veurne (BE)

(21) Appl. No.: 19/129,729

(22) PCT Filed: Nov. 15, 2023
(86) PCT No.: PCT/IB2023/061566

§ 371 Date: May 14, 2025

(30) Foreign Application Priority Data
Nov. 15, 2022 (BE) BE2022/5919
Nov. 24, 2022 (BE) BE2022/5952

(51) Int. Cl. H02G 3/08; H02G 1/00

(52) U.S. Cl. CPC H02G 3/081; H02G 1/00

(57) ABSTRACT

The present invention relates to a method for flush mounting switches and sockets in board material, comprising the steps of making a passage in the board material, placing a flush-mounted box on the rear side of the board material. removably clicking an electrical base element into the flush-mounted box, wherein a central part covers the base element, wherein a front surface of the central part is in the passage or in a plane formed by a front side of the board material, wherein there is a gap between the central part and each side wall of the passage over a distance of at least 0.8 mm and at most 10 mm, wherein, after placing the base element into the flush-mounted box, a filler element is removably placed in the gap and fills the gap over the entire distance. The invention also relates to a kit for flush mounting switches and sockets in board material.

### TECHNICAL FIELD

The invention relates to a method and a kit for flush mounting of switches and sockets, more specifically the flush mounting of switches and sockets in board material.

### PRIOR ART

Flush-mounted boxes for switches and sockets are ubiquitous in a modern home or any other building. Typically, one or more interchangeable sockets or switches are mounted in the flush-mounted boxes, to which electrical wiring runs from the surrounding wall structure. In some cases, other electrical base elements, such as sensors, lights and other components, are mounted in the flush-mounted boxes.

Despite advancements in other areas of technology, sockets and switches have changed little for at least the better part of a century. As is known, flush-mounted boxes usually have the shape of a beam or a cylinder, the front of which is open. The flush-mounted box is attached to a wall with cement or plaster or hooked behind a plaster wall or other board material using clamps, with the open side of the flush-mounted box facing a room. Electrical wiring is led to the flush-mounted box and attached to the electrical base element. The socket, switches or other electrical base element is then installed inside the flush-mounted box. The open front side of the flush-mounted box is then covered by a cover frame with one or more openings through which the active part of the socket, the switches or the other electrical base element protrudes. This type of installation has been used for so many years that, from an aesthetic point of view, most people simply accept the presence of a visible cover frame as a necessary evil. Of course, numerous attempts have been made to improve the appearance of cover frames, but with very mixed results. At best, the cover frame has turned into a more or less decorative item, while at worst, the cover frame is an even more obvious eyesore. In recent years, the trend has been to make the cover plate simple and practical in appearance, in an attempt to minimize the visual impact as much as possible. Homes and commercial buildings, where a sophisticated look is sought, could benefit from eliminating visible cover frames. At the same time, it must be taken into account that flush-mounted boxes have important structural and safety functions. The flush-mounted box provides support for the socket, the switches or other electrical base element and also encloses the wire ends and contacts that would otherwise be exposed. The functional requirements are often described in regulations, from which deviation is not desirable or practical. Consequently, no aesthetic improvement may be made at the expense of violating these regulations.

BE 1 020 913 (BE '913) describes a method for installing sockets in a hard material that serves as a floor, ceiling or wall covering. To this end, holes are made in the hard material for the pins of a plug for said socket and a blind opening for receiving the plug. The contact housing part of the socket is placed directly on a rear side of the hard material. The method according to BE '913 completely avoids the use of a cover frame. A disadvantage of this method is that it is only suitable for hard materials, such as stone and composite, which in themselves provide sufficient insulation and are fireproof. As a result, a method according to BE '913 is not recommended for installing sockets in board material such as that used in furniture, for example. In addition, BE '913 describes a method that can only be used for installing sockets, but not for other electrical base elements, such as switches, sensors, lights and other components. Another major disadvantage of the solution from BE '913 is that if the socket needs to be replaced or there is a fault in the electrical wiring, there must be access to the back of the hard material. This is usually not feasible. In another embodiment of BE '913, the electrical base element is clicked into a housing on the back of the hard material and a disk is cut from the hard material. In the disk, the holes for the pins of the plug and the blind opening are made. The disk is securely attached to the contact housing part. With this embodiment it is possible to remove the disk and thus the socket from the hard material from the front side using a clamp, after which the socket can be replaced or repaired. This embodiment has the significant disadvantage that the clamp is placed against a visible part of the disk, which can cause minor damage to the disk. Additionally, it is necessary to anchor insulated threaded rods at two attachment points in the disk. These threaded rods are necessary to attach the contact housing part to the disk. This is a risky operation because it can lead to cracking or breaking of the disk. Because the disk is made from the hard material, and there is often a continuous pattern in the material in stone, the disk cannot easily be replaced in case of breakage. Installing the threaded rods is also labor intensive.

The present invention aims to solve at least some of the above problems or drawbacks.

### SUMMARY OF THE INVENTION

In a first aspect, the present invention relates to a method according to claim 1.

This method is particularly advantageous because it allows the electrical base element to be removed from the flush-mounted box for replacement or repair after placement from the front of the board material, without having to place a clamp on visible parts of the central part. Because there is a gap between the central part and each side wall of the gap, the electrical base element can be unclicked from the flush-mounted box using a tool placed in the gap. The tool only comes into contact with sides of the central part that face the passage. There is therefore no chance of visible damage to the central part. This is particularly advantageous for central parts that are made from the board material itself, such as stone with a continuous pattern, where the central part cannot be easily replaced. It is also particularly advantageous that the central part and the electrical base element are centered in the passage through the use of the filler element. After the electrical base element has been clicked into the flush-mounted box, it is possible that the electrical base element, due to pushing of electrical wiring on the electrical base element, may end up slightly tilted in the passage. As a result, the gap between the central part and each side wall of the passage is not equal or not regular around the passage, as a result of which the aesthetic effect of an absent cover frame is partly lost. By placing a filler element in the gap, the gap is filled over the entire distance at at least one point between the central part and each side wall and at at least three points between a continuous side wall and the central part, and the electrical base element is automatically centered in the passage.

Preferred forms of the device are shown in claims 2-7.

A specific preferred form concerns a method according to claim 2.

This preferred form is advantageous to prevent dirt or dust from accumulating in the gap, so that a click system with which the electrical base element is clicked into the flush-mounted box remains accessible. In addition, the filler element prevents the electrical base element from being undesirably unclicked from the flush-mounted box by forcing an object into the gap, thereby avoiding a potential safety risk.

Another specific preferred form concerns a method according to claim 3.

This preferred form is advantageous because it completely conceals the presence of a gap, so that a person has no indication of how the electrical base element can be removed from the board material and an inadvertent safety risk cannot arise.

In a second aspect, the present invention concerns a kit according to claim 8.

This kit has the advantage, inter alia, that an electrical base element without a cover frame can be easily installed flush in board material, whereby the electrical base element can be removed for repair or replacement without the risk of minor damage to the central part. An additional advantage is that the electrical base element and the central part are automatically placed centered in a passage in the board material by the filler element, even if electrical wiring presses on the electrical base element. This means that the aesthetic effect of the absent cover frame is not lost.

Preferred forms of the kit are described in dependent claims 9-13.

### DESCRIPTION OF THE FIGURES

FIG. 1 shows a perspective view of a finished socket according to an embodiment of the present invention.

FIG. 2 shows a perspective view of a socket according to an embodiment of the present invention before placement of the filler element.

FIG. 3 shows a top view of a socket according to an embodiment of the present invention.

FIG. 4 shows a cross-section of a finished socket according to an embodiment of the present invention.

FIG. 5 shows a perspective view of a socket after being clicked into a flush-mounted box according to an embodiment of the present invention.

FIG. 6 shows a plan view of a socket after being clicked into a flush-mounted box according to an embodiment of the present invention.

FIG. 7 shows a cross-section of a socket after being clicked into a flush-mounted box according to an embodiment of the present invention.

FIG. 8 shows a perspective view from another direction of a socket after being clicked into a flush-mounted box according to an embodiment of the present invention.

FIG. 9 shows a perspective view of a finished socket according to an alternative embodiment of the present invention.

FIG. 10 shows a cross-section of a finished socket according to an alternative embodiment of the present invention.

FIG. 11 shows a perspective view from another direction of a finished socket according to an embodiment of the present invention.

### DETAILED DESCRIPTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise”, “comprising”, “consist of”, “consisting of”, “provided with”, “include”, “including”, “contain”, “containing”, are synonyms and are inclusive or open terms that indicate the presence of what follows, and which do not exclude or prevent the presence of other components, characteristics, elements, members, steps, as known from or disclosed in the prior art.

Quoting numeric intervals by the endpoints includes all integers, fractions, and/or real numbers between the endpoints, including those endpoints.

In the context of this document, an electrical base element is an element that is placed through an opening in a flush-mounted box, where a functional part of the electrical base element is accessible through the opening in the flush-mounted box. Non-limiting examples of electrical base elements are sockets, switches such as switches, push-buttons, sensors, orientation lighting, data connections, multimedia connections, etc. The electrical base element typically comprises provisions for removably attaching the electrical base element in the flush-mounted box, such as clamps, keyhole slots, notches or cams for interaction with flexible arms of a click system, etc.

In the context of this document, a central part is a cover plate for covering a central part of an electrical base element. The cover plate has both an aesthetic function and a safety function. After placement, the central part covers live parts of the electrical base element. The central part usually does not cover the facilities for removably attaching the electrical base element in the flush-mounted box. Non-limiting examples of a central part are a pushing part of a switch or push-button, a cover plate of a socket, a lens of a sensor or orientation light, etc.

In the context of this document, a cover frame is a cover plate with at least one opening for a central part. After placement of the cover frame, the central part is located in the at least one opening of the cover frame. The cover frame preferably connects around the central part in the at least one opening. The cover frame covers, after placement, a flush-mounted box and not yet covered facilities for the removable attachment of an electrical base element in the flush-mounted box of an electrical base element placed in the flush-mounted box.

In the context of this document, concentric means having a common center, for example a common center in the case of circles, a common center in the case of squares or rectangles, where outlines of for example circles, squares or rectangles do not touch or intersect each other, wherein a distance between an outline of a first concentric circle, square or rectangle and an outline of a second concentric circle, square or rectangle remains the same along the circumference of the first concentric circle, square or rectangle and where the mentioned distance is measured perpendicular to the outline of the first concentric circle, square or rectangle.

In the context of this document, board material means a flat piece of material, suitable for floor, wall or ceiling covering or as a furniture wall. Non-limiting examples are panels made of plaster, stone, composite, ceramics, MDF boards, chipboards, etc.

In a first aspect, the invention concerns a method for flush mounting of switches and sockets in board material.

According to a preferred embodiment, the method comprises the steps of:
making a passage for an electrical base element in the board material;
placing a flush-mounted box with an opening on a rear side of the board material, wherein the opening of the flush-mounted box is located at the passage; and
placing the electrical base element through the passage in the flush-mounted box.

The board material is used as a floor covering, wall covering, ceiling covering, furniture wall or as another suitable wall for installing electrical base elements. The board material may or may not be covered, for example with wallpaper in the case of wall coverings or with textile or leather in the case of a furniture wall.

The passage has a circular outline in a plane formed by the rear side of the board material. The passage in this case is a cylindrical passage. The passage comprises a continuous side wall transverse to the rear side of the board material that bounds the passage. The passage is drilled into the board material or milled or sawn from the board material. The passage is preferably drilled in the board material.

Alternatively, the passage in the plane formed by the rear side of the board material has a rectangular outline. The passage in this case is a beam-shaped passage. The passage comprises at least four side walls transverse to the rear side of the board material that bounds the passage. The passage is milled or sawn from the board material.

It will be apparent that other suitable shapes are possible for the passage.

The opening of the flush-mounted box is in a plane. The opening of the flush-mounted box is limited by side walls transverse to the plane of the opening. The plane of the opening is the plane in which the opening of the flush-mounted box lies. A flush-mounted box with a circular opening comprises a continuous side wall that forms a cylindrical body. A flush-mounted box with a rectangular opening comprises at least four side walls that form a beam-shaped body. The flush-mounted box can, but does not have to, include a bottom opposite the opening. The opening of the flush-mounted box preferably has the same shape as the passage in the board material. This is advantageous for correctly placing and aligning the flush-mounted box on the rear side of the board material.

A central part is placed on the electrical base element. The central part can be placed on the electrical base element before or after placing the electrical base element in the flush-mounted box. When placing the central part before placing the electrical base element in the flush-mounted box, the central part is preferably attached to the electrical base element. The central part covers the electrical base element. A front surface of the central part is located in the passage or in a plane formed by a front side of the board material. The front surface of the central part is viewed in a direction transverse to the front of the board material and towards the rear side of the board material. There is a gap between the central part and each side wall of the passage. In the case of a cylindrical passage, each side wall is the continuous side wall that bounds the passage. Between each side wall of the passage and the central part there is a distance of at least 0.8 mm and a maximum of 10 mm in the plane formed by the front side of the board material. The distance is preferably at most 9 mm, more preferably at most 8 mm, even more preferably at most 7 mm, even more preferably at most 6 mm and most preferably at most 5 mm. The distance is measured perpendicular to each side wall. The central part and side walls of the passage are concentric, viewed in a plane parallel to the plane formed by the front side of the board material. The passage comprises a central axis, transverse to the plane formed by the front side of the board material and through a center of the passage. The flush-mounted box comprises a central axis, transverse to the opening of the flush-mounted box and through a center of the opening of the flush-mounted box. The central part comprises a central axis, transverse to the front surface of the central part and through a center of the central part. The distance between the central part and each side wall of the passage is measured with an ideal placement of the electrical base element. An ideal placement means that the central axis of the passage, the central axis of the flush-mounted box and the central axis of the central part coincide. A central part that is placed on the electrical base element is advantageous because identical electrical base elements can be finished differently by placing a central part with a different color or made of a different material. The central part can be made of a material different from or the same as the board material. A central part made from the board material is particularly advantageous if the board material is electrically insulating and fireproof, such as, for example, but not limited to stone and composite, because this makes the central part virtually invisible in the board material.

If the electrical base element must be connected to electrical wiring behind the board material, this is preferably done before placing the electrical base element in the flush-mounted box. The electrical base element is removably clicked into the flush-mounted box. The flush-mounted box comprises flexible arms in side walls along the opening of the flush-mounted box. The electrical base element comprises notches or cams for interaction with the flexible arms. Optionally, the flexible arms comprise barbs. It will also be apparent that embodiments in which the flexible arms are included in the electrical base element and in which the notches or cams for interaction with the flexible arms are included in the flush-mounted box are also part of the described invention. In other words, in the description, the flexible arms and the notches or cams for interacting with the flexible arms are interchangeable. The flush-mounted box preferably comprises stops on side walls along the opening or on the bottom of the flush-mounted box for limiting a translational movement of the electrical base element in a direction transverse to the opening towards the flush-mounted box. This prevents the electrical base element from being pressed deeper into the flush-mounted box when pressing on the electrical base element, in particular sockets and switches.

Clicking the electrical base element into place removably is advantageous because it allows the electrical base element to be easily replaced in the event of a defect or, in the event of a wiring problem, to be easily removed to repair electrical wiring or electrical connections. Clicking the electrical base element into place is particularly advantageous to avoid the use of a cover frame. Electrical base elements are traditionally removably attached in the flush-mounted box using a mounting plate with keyhole slots. The mounting plate here rests on the board material and the electrical base element is screwed down with screws through the keyhole slots on the side walls along the opening of the flush-mounted box. A cover frame is necessary to hide the mounting plate. A known alternative solution is to removably attach the electrical base element in the flush-mounted box using clamps. Such clamps are unfolded along the opening of the flush-mounted box with screws against side walls. To this end, these screws must be freely accessible along the electrical base element, which means a larger gap must be provided, which is not desirable. These clamps are usually part of a mounting plate as described previously, which again requires a cover frame. Clamps are also not recommended when mounting the electrical base element in board material because these clamps must be able to engage in the side walls along the opening of the flush-mounted box. Due to the thickness of the board material, the clamps may not reach far enough.

After placing the electrical base element in the flush-mounted box, a filler element is removably placed in the gap between each side wall of the passage and the central part. The filler element can be made of flexible, compressible material or of a rigid material, or a combination of both. Non-limiting examples of suitable materials are metal, plastic and rubber. The rubber may or may not be synthetic. When using metal as a filler element, due attention must be paid to sufficient distance or isolation between the filler element and electrical parts of the electrical base element or electrical wiring. The gap is filled over the entire distance at at least one point between each side wall of the passage and the central part and at at least three points between a continuous side wall of the passage and the central part. In the case of a continuous side wall, each side wall is equal to the continuous side wall. It will be apparent that at at least one point between each side wall and the central part and at at least three points between a continuous side wall and the central part are compatible with each other. The filler element preferably has a minimum height of 2 mm, where the height of the filler element after placement in the gap is measured in a direction transverse to the plane formed by the front side of the board material. More preferably, the filler element has a minimum height of 3 mm, even more preferably a minimum height of 4 mm. The filler element extends in the mentioned direction transversely to the plane formed by the front side of the board material, whether or not up to the plane formed by the front side of the board material. If the filler element does not extend to the plane formed by the front side of the board material, the filler element is sunk into the flush-mounted box.

This method is particularly advantageous because it allows the electrical base element to be removed from the flush-mounted box for replacement or repair after placement from the front of the board material, without having to place a clamp on visible parts of the central part. Because there is a gap between the central part and each side wall of the gap, the electrical base element can be unclicked from the flush-mounted box using a tool placed in the gap. In such a situation the tool pushes the flexible arms of the flush-mounted box or the flexible arms of the electrical base element aside, so that they no longer interact with notches or cams in the electrical base element or the flush-mounted box, respectively. The tool only comes into contact with sides of the central part that face the passage. There is therefore no chance of visible damage to the central part. This is particularly advantageous for central parts that are made from the board material itself, such as stone with a continuous pattern, where the central part cannot be easily replaced. After all, replacing the central part would disrupt a pattern in the board material. It is also particularly advantageous that the central part and the electrical base element are centered in the passage through the use of the filler element. After the electrical base element has been clicked into the flush-mounted box, it is possible that the electrical base element, due to pushing of electrical wiring on the electrical base element, may end up slightly tilted in the passage. As a result, the gap between the central part and each side wall of the passage is not equal or not regular around the passage, as a result of which the aesthetic effect of an absent cover frame is partly lost. By placing a filler element in the gap, the gap is filled over the entire distance at at least one point between the central part and each side wall and at at least three points between a continuous side wall and the central part, and the electrical base element is automatically centered in the passage.

According to an embodiment, in the event that the gap is filled at at least three points between the continuous side wall and the central part, the at least three points are not all located in the same half-space, where a diameter of the opening of the flush-mounted box lies in a plane that bounds the half-space and where said plane is perpendicular to the opening. Preferably, the at least three points are distributed evenly along an outline of the opening.

According to a preferred embodiment, the gap in a plane parallel to the plane formed by the front side of the board material along an outline formed by the side walls of the passage in said plane is filled by the filler element over the entire distance between the central part and each side wall of the passage. It will be apparent that in the case of a continuous side wall, each side wall is equal to the continuous side wall.

This embodiment is advantageous to prevent dirt or dust from accumulating in the gap, so that a click system with which the electrical base element is clicked into the flush-mounted box remains accessible. In addition, the filler element prevents the electrical base element from being undesirably unclicked from the flush-mounted box by forcing an object into the gap, thereby avoiding a potential safety risk.

According to a preferred embodiment, a front surface of the filler element is located in the plane formed by the front side of the board material.

The front surface of the filler element is viewed in a direction transverse to the plane formed by the front side of the board material and towards the rear side of the board material. This embodiment is particularly advantageous for flush mounting of an electrical base element in board material. This is particularly advantageous in cases in which the front surface of the central part is also located in the plane formed by the front side of the board material, such as, for example, a pressing surface of a switch or push-button or a lens of an orientation lighting, resulting in a visually continuous floor, wall or ceiling covering or furniture wall is obtained, in contrast to a traditional cover frame, where the central parts emerge from the board material. Even with a front surface that is located in the passage, such as a socket, a visually continuous wall is obtained, with a local recess for receiving a plug of a power cord. A recessed filler element would emphasize a visible gap around the central part, which would emphasize the central part in the board material more. This embodiment is also advantageous because it completely conceals the presence of the gap, so that a person has no indication of how the electrical base element can be removed from the board material and an inadvertent safety risk cannot arise.

According to a preferred embodiment, the filler element comprises a flange. The flange lies in a plane parallel to the plane of the opening of the flush-mounted box. The flange extends in a direction away from the electrical base element. This means that the opening is not partially covered by the flange. When placing the filler element, the flange hides the flush-mounted box. The flange preferably has a width of at least 2 mm, more preferably at least 3 mm. The flange preferably has a width of at most 10 mm, more preferably at most 8 mm, even more preferably at most 6 mm. The width is measured in the plane of the opening and transverse to an edge of the opening.

The flange lies against the front side of the board material. The front side of the board material is parallel to the plane of the opening of the flush-mounted box. The flange does not necessarily lie in the plane of the opening of the flush-mounted box. In that case, to measure the width of the flange, the flange is projected onto the plane of the opening of the flush-mounted box.

This embodiment is advantageous because only the central part and the filler element are visible.

The flange covers the passage and the board material on an edge of the passage, thereby achieving a neat finish. If the board material at the edge of the passage is damaged when making the passage, such as splinters in the case of wooden board material or small chips in the case of stone board material, the flange will cover this minor damage. Thus, there is no need to repair or touch up the edge of the passage.

According to a preferred embodiment, the central part is attached to the electrical base element before placing the electrical base element. Attaching the central part to the electrical base element is advantageous because the central part is also immediately placed firmly in the flush-mounted box and in the passage by clicking the electrical base element into place. The central part is preferably clicked onto the electrical base element. Clicking the central part onto the electrical base element is advantageous to avoid disruption of the front surface of the central part by a fastening means. Alternatively, the central part is screwed to the electrical base element using at least one screw. Preferably, the at least one screw in the front surface of the central part is not visible, for example because the at least one screw is screwed into the central part from a rear side through the electrical base element. Alternatively, the central part is attached to the electrical base element using at least one magnet. The central part or the electrical base element comprises the at least one magnet, while the electrical base element or the central part respectively comprises a ferromagnetic material. The at least one magnet is advantageous for removably attaching the central part to the electrical base element, without the front surface of the central part being disturbed by a fastening means.

According to a preferred embodiment, the central part is placed loosely on the electrical base element after placing the electrical base element in the flush-mounted box. The central part is clamped in the passage by placing the filler element.

Preferably, the filler element is made of a flexible, compressible material. A non-limiting example of a suitable material is rubber, synthetic or otherwise. A flexible, compressible material is advantageous for absorbing any margins in the dimensions of the passage or the central part. A non-limiting example of a filler element made of a flexible, compressible material is a cylindrical shape made of rubber that is placed around the central part. The cylindrical shape may or may not comprise a bottom made of rubber, wherein the bottom is positioned between the central part and the electrical base element or wherein the bottom comprises an opening for the electrical base element. Alternatively, the filler element is made of a rigid material, such as plastic, metal or wood, and a flexible compressible material is applied on a side of the filler element that is in contact with the passage, on a side of the filler element that is in contact with the central part or on both said sides. An alternative to a flexible, compressible material is an annular coil spring arranged around the filler element.

This embodiment is advantageous to avoid disruption of the front surface of the central part by a fastening means. This embodiment is particularly advantageous because it allows the central part to be made from a material that is not suitable for the use of, for example, click systems, screws or magnets, such as natural stone, ceramics, glass, etc. Clamping the central part by the filler element prevents the central part from having to be further processed in these cases, which could cause these central parts to crack or break. This embodiment is extremely advantageous for the flat and virtually invisible placement of an electrical base element in board material made of, for example, natural stone, ceramic, glass and similar materials, by providing a central part made of the same material.

According to an embodiment, the filler element is integrated into the central part. Preferably, the filler element and the central part are one piece. This embodiment is particularly advantageous in cases where the central part is placed on the electrical base element after placing the electrical base element in the flush-mounted box. Because the filler element is integrated into the central part, only one additional element needs to be installed after placement of the electrical base element, instead of two additional elements. The central part with the integrated filler element can be magnetically attached to the electrical base element, as described previously. Alternatively, the central part with integrated filler element can be attached in the flush-mounted box by clicking the filler element into the gap, as described previously. Alternatively, the central part with integrated filler element can be clamped in the gap, as described previously.

According to a preferred embodiment, the filler element is clicked into place in the gap. Preferably, the filler element comprises several protrusions that are accommodated in recesses in the central part, the electrical base element or both. It will be apparent that the protrusions and recesses are interchangeable. Preferably, the filler element comprises a notch for unclicking the filler element from the gap. Alternatively, the central part comprises a notch for unclicking the filler element from the gap.

This embodiment is advantageous because the filler element can be removably placed in the gap without the use of tools.

According to an alternative embodiment, the filler element is clamped in the gap. This embodiment is also advantageous for removably placing the filler element in the gap without the use of tools. This embodiment is particularly advantageous in combination with a filler element made of a flexible, compressible material or with a filler element made of a rigid material, wherein a flexible, compressible material is provided on one or two sides, as in a previously described embodiment. An alternative to a flexible, compressible material is an annular coil spring arranged around the filler element. With a filler element made of a rigid material, the filler element preferably comprises a notch for releasing the filler element from the gap. Alternatively, the central part comprises a notch for releasing the filler element from the gap.

According to an embodiment, the flush-mounted box comprises a plurality of openings. When carrying out the method, an electrical base element and a central part are placed in each of the openings, as described in previous embodiments. This embodiment is advantageous for placing electrical base elements close to each other, wherein the electrical base elements are automatically aligned.

According to an embodiment, before placing the electrical base element in the flush-mounted box, the method comprises the additional step of orienting the electrical base element in the flush-mounted box. The electrical base element can be rotated in discrete steps of at least 30° around the central axis of the electrical base element, before the electrical base element is clicked into the flush-mounted box. The discrete steps are preferably at least 36°, more preferably at least 45°. The discrete steps are preferably at most 180°, more preferably at most 90°, even more preferably at most 60°. This embodiment is advantageous for mounting an electrical base element at an angle relative to a horizontal floor surface. This embodiment is particularly advantageous when placing a socket in a flush-mounted box, in particular with sockets placed closely together or sockets close to a surface. By rotating the socket, more free space can be created for routing a power cord.

According to an embodiment, the central part is made of the same material as the board material. The board material is preferably electrically insulating and fireproof, such as but not limited to stone, ceramics, glass, composite, etc. This embodiment is advantageous for virtually invisibly mounting electrical base elements in the board material.

According to an embodiment, the central part is made of a material that is different from the board material. This embodiment is advantageous if the board material is not sufficiently electrically insulating or insufficiently fireproof, such as some board materials used as furniture walls.

According to an embodiment, the passage is a cylindrical passage in the board material, wherein the passage has a diameter of at most 55 mm, preferably at most 52.5 mm, more preferably at most 50 mm, even more preferably at most 49 mm and even more preferably at most 48 mm. This embodiment is advantageous because as a result the passage has minimal dimensions, so that a front side of the board material is disturbed as little as possible, while the passage is still sufficiently large for the placement of a central part that can receive a plug according to the CEE 7-Modification 4 (1983-03) standard.

In a second aspect, the invention concerns a kit for flush mounting switches and sockets in board material.

According to a preferred embodiment, the kit comprises a flush-mounted box, an electrical base element, a central part and furthermore a filler element for filling a gap in a passage for the electrical base material in the board material.

The flush-mounted box comprises an opening for placing the electrical base element in the flush-mounted box. The flush-mounted box comprises a mounting surface for placing the flush-mounted box with the mounting surface on a rear side of the board material. The opening of the flush-mounted box is located in the mounting surface. The opening of the flush-mounted box is limited by side walls transverse to the mounting surface. The flush-mounted box can, but does not have to, include a bottom opposite the opening. The flush-mounted box comprises fastening means for removably attaching the electrical base element in the flush-mounted box. The fastening means are suitable for clicking the electrical base element into the flush-mounted box. Preferably, the flush-mounted box comprises as fastening means flexible arms in side walls along the opening of the flush-mounted box and the electrical base element comprises notches or cams for interaction with the flexible arms. Optionally, the flexible arms comprise barbs. It will be apparent that embodiments in which the flexible arms are included in the electrical base element and in which the notches or cams for interaction with the flexible arms are included in the flush-mounted box are also part of the described invention. The flush-mounted box preferably comprises stops on side walls along the opening of the flush-mounted box or on the bottom of the flush-mounted box for limiting a translational movement of the electrical base element in a direction transverse to the opening towards the flush-mounted box. The central part can be placed on the electrical base element. The central part covers the electrical base element, after mounting the electrical base element in the flush-mounted box and after placing the central part on the electrical base element. A front surface of the central part is located outside the flush-mounted box after mounting the electrical base element in the flush-mounted box and after placing the central part on the electrical base element. The front surface of the central part is viewed in a direction transverse to the mounting surface and towards the flush-mounted box.

After placement of the electrical base element in the flush-mounted box, after placement of the central part on the electrical base element and after placement of the filler element in the gap in the passage, the central part has an outline in a plane parallel to the mounting surface of the flush-mounted box, whereby the filler element fits adjoining the mentioned outline of the central part. The filler element extends from the central part at at least one point of each side wall of the central part or at at least three points of a continuous side wall of the central part over a distance of at least 0.8 mm. In the case of a continuous side wall of the central part, each side wall is equal to the continuous side wall. It will be apparent that from at least one point of each side wall of the central part and from at least three points of a continuous side wall of the central part are compatible with each other. The filler element can be made of flexible, compressible material or of a rigid material. Non-limiting examples are metal, plastic and rubber. The rubber may or may not be synthetic. The filler element extends from the central part along the said outline over a distance of no more than 10 mm. The distance is preferably at most 9 mm, more preferably at most 8 mm, even more preferably at most 7 mm, even more preferably at most 6 mm and most preferably at most 5 mm. The distance from a side wall of the central part is measured transversely to said side wall of the central part. The filler element preferably has a minimum height of 2 mm, where the height of the filler element after filling the gap is measured in a direction transverse to the mounting surface of the flush-mounted box. More preferably, the filler element has a minimum height of 3 mm, even more preferably a minimum height of 4 mm.

This kit has the advantage, inter alia, that an electrical base element without a cover frame can be easily installed flush in board material, whereby the electrical base element can be removed for repair or replacement without the risk of minor damage to the central part. An additional advantage is that the electrical base element and the central part are automatically placed centered in a passage in the board material by the filler element, even if electrical wiring presses on the electrical base element. This means that the aesthetic effect of the absent cover frame is not lost.

According to an embodiment, in the event that after placement of the filler element the gap is filled at at least three points between the continuous side wall and the central part, the at least three points are not all located in the same half-space, where a diameter of the opening of the flush-mounted box lies in a plane that bounds the half-space and where said plane is perpendicular to the opening. Preferably, the at least three points are distributed evenly along an outline of the opening.

According to a preferred embodiment, the filler element extends over a distance of at least 0.8 mm after placement from the central part along the said outline. This is advantageous because it means that the filler element extends along the entire said outline sufficiently to fill the gap over the entire distance with a minimal gap. This is advantageous to prevent dirt or dust from accumulating in the minimal gap between the electrical base element and the side walls of the passage after placement, as a result of which the electrical base element could no longer be unclicked from the flush-mounted box. An additional advantage is that the filler element in the kit ensures that the electrical base element cannot be undesirably unclicked from the flush-mounted box after placement by forcing an object into the minimal gap. This avoids a possible safety risk.

According to a preferred embodiment, the filler element extends from the central part along the said outline over an equal distance. This embodiment is advantageous because it automatically makes an outline of the passage and the said outline of the central part concentric.

According to a preferred embodiment, the filler element comprises a flange.

After placement of the filler element, the flange lies in a plane parallel to the plane of the opening of the flush-mounted box. After placement of the filler element, the flange extends in a direction away from the electrical base element and at least beyond the flush-mounted box. The flange preferably has a width of at least 2 mm, more preferably at least 3 mm. The flange preferably has a width of at most 10 mm, more preferably at most 8 mm, even more preferably at most 6 mm. The width is measured in the plane of the opening and transverse to an edge of the opening.

After placement, the flange lies against the front side of the board material. The front side of the board material is parallel to the plane of the opening of the flush-mounted box. The flange does not necessarily lie in the plane of the opening of the flush-mounted box. In that case, to measure the width of the flange, the flange is projected onto the plane of the opening of the flush-mounted box.

This embodiment is advantageous because only the central part and the filler element are visible.

The flange covers the passage and the board material on an edge of the passage, thereby achieving a neat finish. If the board material at the edge of the passage is damaged when making the passage, such as splinters in the case of wooden board material or small chips in the case of stone board material, the flange will cover this minor damage. Thus, there is no need to repair or touch up the edge of the passage.

According to a preferred embodiment, the filler element comprises means for clamping the filler element in a passage in the board material. The filler element is made of a flexible, compressible material. Alternatively, the filler element is made of a rigid material, with a flexible, compressible material applied on one or two sides. An alternative to a flexible, compressible material is an annular coil spring arranged around the filler element. By sizing the filler element slightly larger than the passage, the flexible, compressible material or coil spring will be compressed and the filler element clamped into the passage. With a filler element made of a rigid material, the filler element preferably comprises a notch for releasing the filler element from the gap. Alternatively, the central part comprises a notch for releasing the filler element from the gap. This embodiment is advantageous because the filler element can be removably placed in the gap without the use of tools.

According to a preferred embodiment, the filler element comprises means for clicking the filler element onto the central part. Preferably, the filler element comprises several protrusions that are accommodated in recesses in the central part, the electrical base element or both. It will be apparent that the protrusions and recesses are interchangeable. Preferably, the filler element comprises a notch for unclicking the filler element from the gap. Alternatively, the central part comprises a notch for unclicking the filler element from the gap. This embodiment is advantageous because the filler element can be removably placed in the gap without the use of tools.

According to a preferred embodiment, the filler element can be clamped onto the central part. The filler element is made of a flexible, compressible material. Alternatively, the filler element is made of a rigid material, with a flexible, compressible material provided on a side facing the central part. An alternative to a flexible, compressible material is an annular coil spring mounted along an inner outline of the filler element. By sizing the filler element slightly smaller than the central part, the flexible, compressible material or the coil spring will be compressed and the filler element is clamped to the central part.

One skilled in the art will appreciate that a method according to the first aspect is preferably performed with a kit according to the second aspect and that a kit according to the second aspect is preferably suitable for performing a method according to the first aspect. Each feature described in this document, both above and below, can therefore relate to any of the two aspects of the present invention.

In what follows, the invention is described by way of non-limiting figures illustrating the invention, and which are not intended to and should not be interpreted as limiting the scope of the invention.

### DESCRIPTION OF THE FIGURES

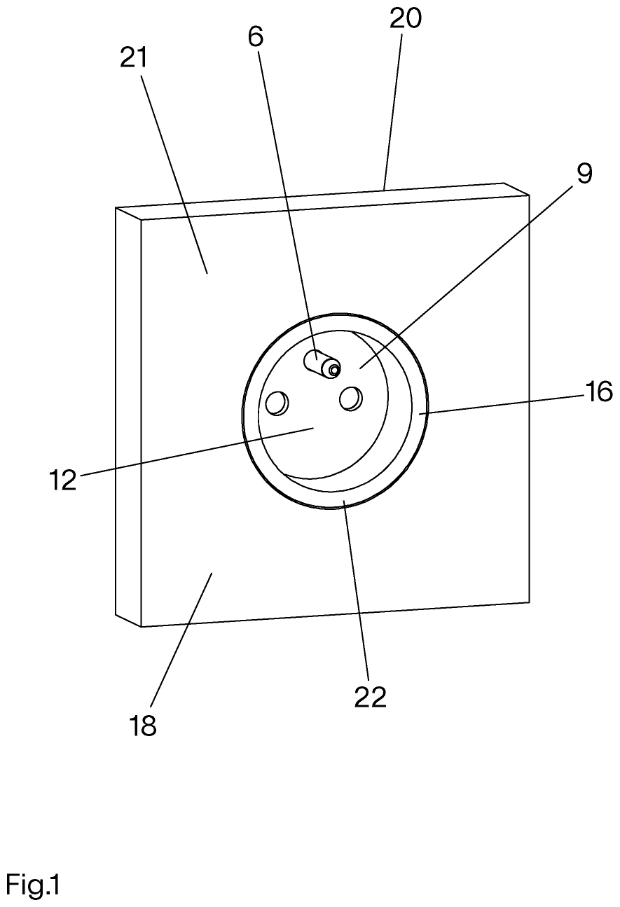

FIG. 1 shows a perspective view of a finished socket according to an embodiment of the present invention.

A passage (19) for an electrical base element (6) has been made in board material (18). In this embodiment, the electrical base element (6) is a socket of which only an earth pin is visible. The passage (19) is a cylindrical perforation in the board material (18). A flush-mounted box (1) is placed at the rear side (20) of the board material (18). The flush-mounted box (1) is not visible in FIG. 1 but will be clearly shown in later figures. The flush-mounted box (1) comprises an opening (2) that is located at the passage (19). The electrical base element (6) is clicked into the flush-mounted box (1) through the passage (19). A central part (9) is placed on the electrical base element (6). The central part (9) covers the electrical base element (6). A front surface (12) of the central part (9) lies in the passage (19). The passage (19) is bounded by a continuous side wall (15), transverse to a plane formed by a front side (21) of the board material (18). There is a gap (13) between the continuous side wall (15) and the central part. A filler element (16) is removably placed in the gap (13). In this embodiment, the filler element (16) fills the gap (13) in the plane formed by the front side (21) of the board material (18) along an outline formed by the continuous side wall (15) of the passage (19) in the said plane, over a full distance (14) between the central part (9) and the continuous side wall (15). A front surface (22) of the filler element (16) lies in the plane formed by the front side (21) of the board material (18), so that the passage (19), the continuous side wall (15) and the gap (13) are not visible.

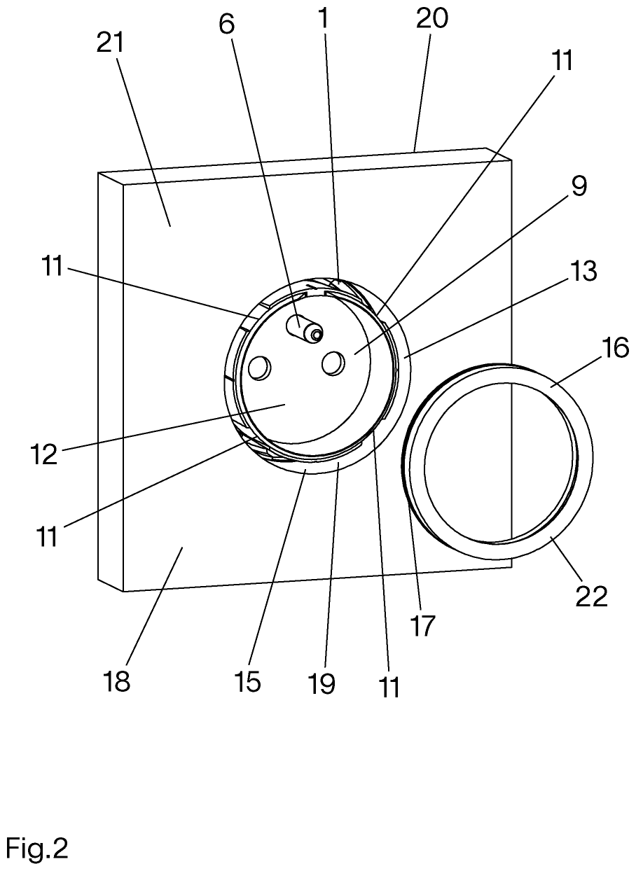

FIG. 2 shows a perspective view of a socket according to an embodiment of the present invention before placement of the filler element.

This embodiment corresponds to the embodiment in FIG. 1. The difference is that the filler element (16) has been removed from the gap (13). This now makes the passage (19), the continuous side wall (15) and the gap (13) visible. The filler element (16) comprises an annular coil spring (17) for clamping the filler element (16) in the passage (19). Also visible are slots (11) in the central part (9) that simplify the insertion of a tool for detaching the electrical base element (6). The tool has elongated protrusions that are guided through the slots (11) along the central part (9) and along the electrical base element (6). These elongated protrusions push flexible arms (4) comprised in the flush-mounted box (1) outward, so that they no longer interact with cams (7) of the electrical base element (6) and whereby the electrical base element (6) can be unclicked from the flush-mounted box (1). The flush-mounted box (1), the flexible arms (4) and the cams (7) are clearly shown in further figures.

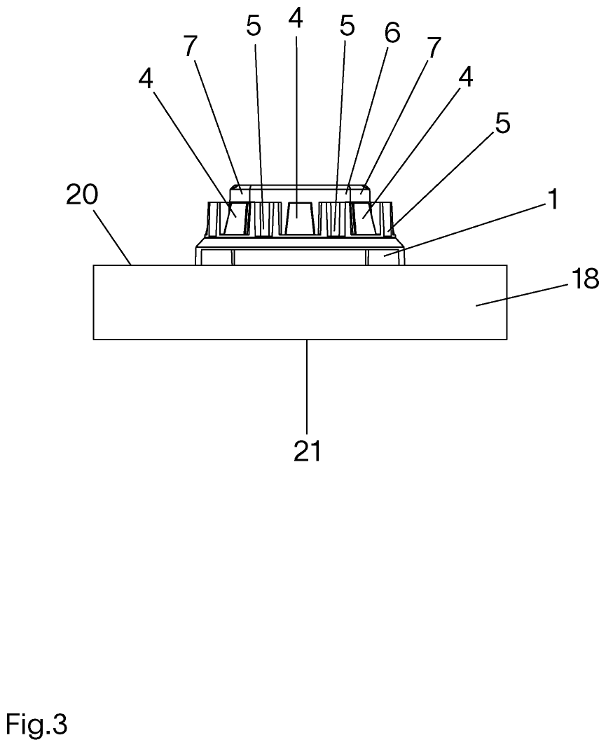

FIG. 3 shows a top view of a socket according to an embodiment of the present invention.

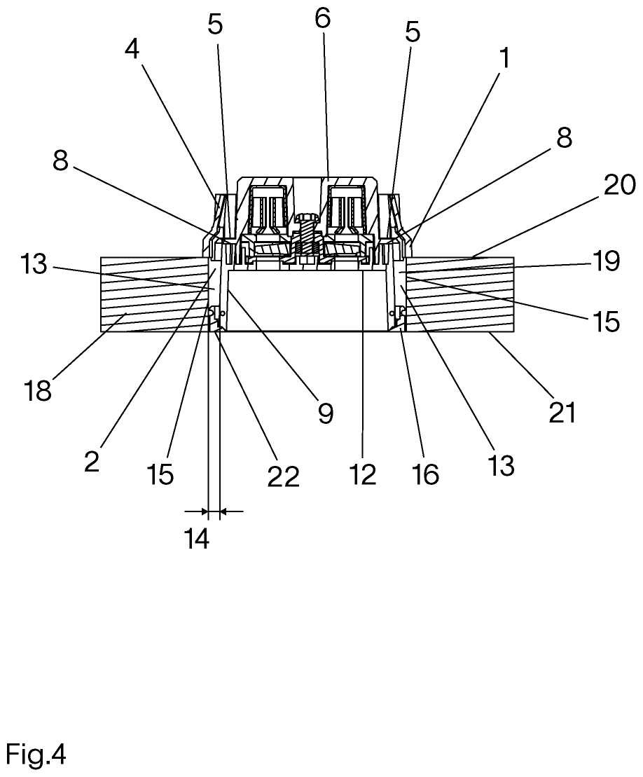

This embodiment corresponds to the embodiment in FIG. 1 and FIG. 2. FIG. 1 shows how flexible arms (4) are prestressed inward. This causes two of the three visible flexible arms (4) to interact with cams (7) of the electrical base element (6), causing the electrical base element to click into the flush-mounted box (1). Also visible are stops (5) for limiting a translational movement of the electrical base element (6) in a direction transverse to the opening (2) directed towards the flush-mounted box (1). The cross-section of FIG. 4 clearly shows the interaction of the stops (5) with an edge (8) of the electrical base element (6).

FIG. 4 shows a cross-section of a finished socket according to an embodiment of the present invention.

This embodiment corresponds to the embodiment in FIG. 1, FIG. 2 and FIG. 3. It is clearly visible how the filler element (16) fills the gap (13) between the continuous side wall (15) and the central part (9) over a full distance (14). The distance (14) is measured transversely to the continuous side wall (15). It is also visible how the opening (2) of the flush-mounted box (1) is located at the passage (19) and how the front surface (12) of the central part (9) is located in the passage (19). An edge (8) of the electrical base element (6) rests against the stops (5) of the flush-mounted box (1), limiting a translational movement of the electrical base element (6) in the direction perpendicular to the opening (2) directed towards the flush-mounted box (1).

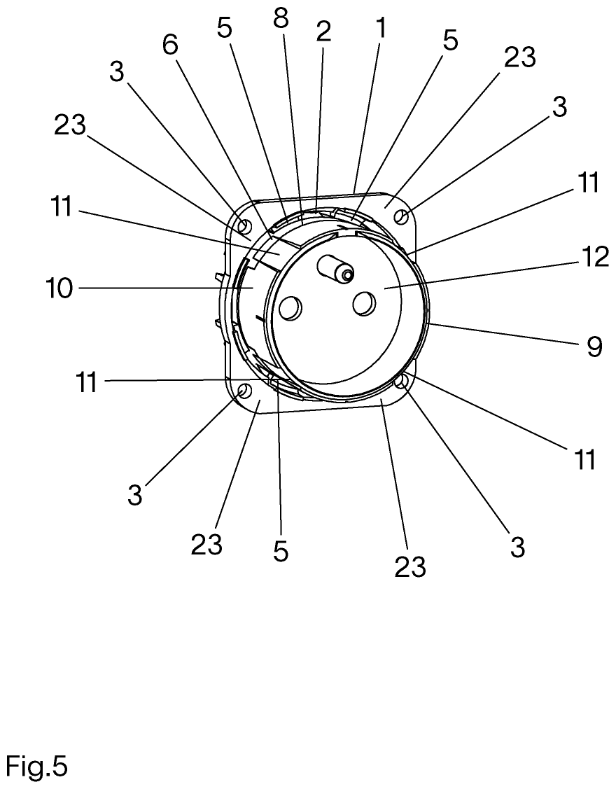

FIG. 5 shows a perspective view of a socket after being clicked into a flush-mounted box according to an embodiment of the present invention.

The flush-mounted box (1), the electrical base element (6) and the central part (9) correspond to the embodiments in the previous figures. By omitting the board material (18) and the filler element (16), the mounting surface (23) of the flush-mounted box (1) is clearly visible. After placement of the flush-mounted box, the mounting surface (23) rests against the rear side (20) of the board material (18). The mounting surface (23) is glued to the rear side (20) or is attached to the board material using screws or nails through the screw holes (3). In this embodiment, the central part (9) is clicked onto the electrical base element (6). To this end, the central part (9) comprises protrusions (10) that interact with non-visible notches in the electrical base element (6).

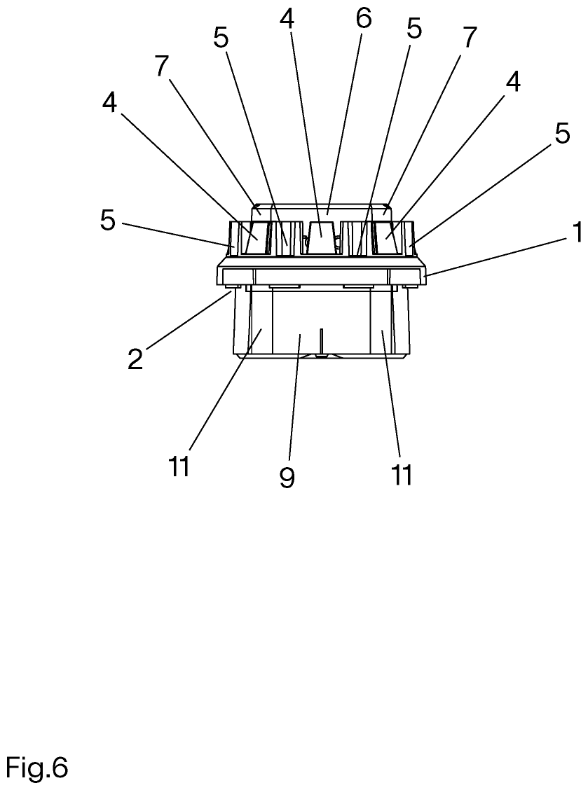

FIG. 6 shows a plan view of a socket after being clicked into a flush-mounted box according to an embodiment of the present invention.

The flush-mounted box (1), the electrical base element (6) and the central part (9) correspond to FIG. 5. The middle flexible arm (4) does not interact with a cam (7) of the electrical base element (6). The flush-mounted box (1) comprises two groups of four flexible arms (4) that are rotated through an angle of 45° relative to each other. This makes the electrical base element (6) rotatable in discrete steps of 45° around a central axis of the electrical base element (6) before the electrical base element (6) is clicked into the flush-mounted box. In each case, only one group of four flexible arms (4) will interact with the cams (7) of the electrical base element (6). The same applies to the stops (5) and the edges (8).

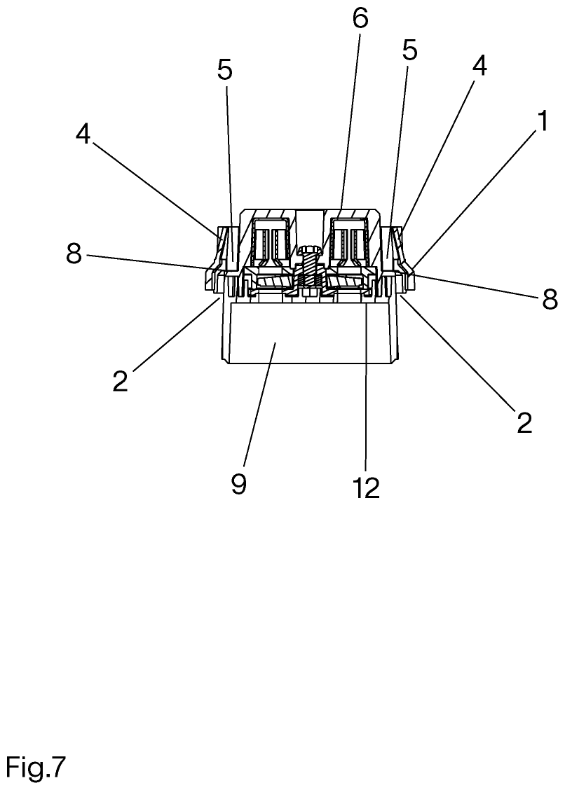

FIG. 7 shows a cross-section of a socket after being clicked into a flush-mounted box according to an embodiment of the present invention.

The flush-mounted box (1), the electrical base element (6) and the central part (9) correspond to FIG. 5 and FIG. 6. It can be seen how around the opening (2) there is a small raised edge. This raised edge is advantageous for correctly aligning the opening (2) with the passage (19).

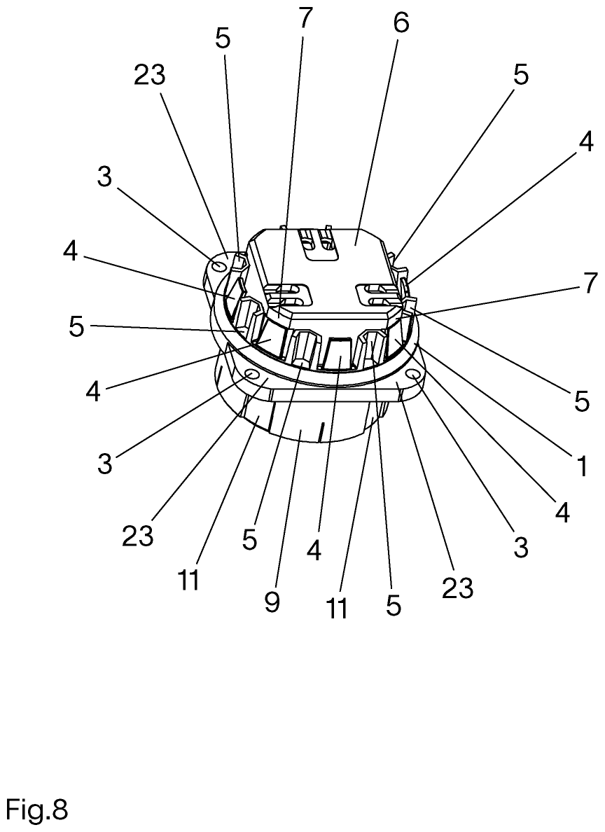

FIG. 8 shows a perspective view from another direction of a socket after being clicked into a flush-mounted box according to an embodiment of the present invention.

The flush-mounted box (1), the electrical base element (6) and the central part (9) correspond to FIG. 5, FIG. 6 and FIG. 7. Clearly visible are the two groups of four flexible arms (4) that are rotated through an angle of 45° relative to each other. Also visible are the two groups of four stops (5) that have been rotated through an angle of 45° relative to each other. This makes the electrical base element (6) rotatable in discrete steps of 45° around a central axis of the electrical base element (6) before the electrical base element (6) is clicked into the flush-mounted box. The flush-mounted box (1) has no bottom opposite the opening (2). It will be apparent that if required the flush-mounted box (1) can comprise a semi-closed volume with a bottom within which the electrical base element (6) is located.

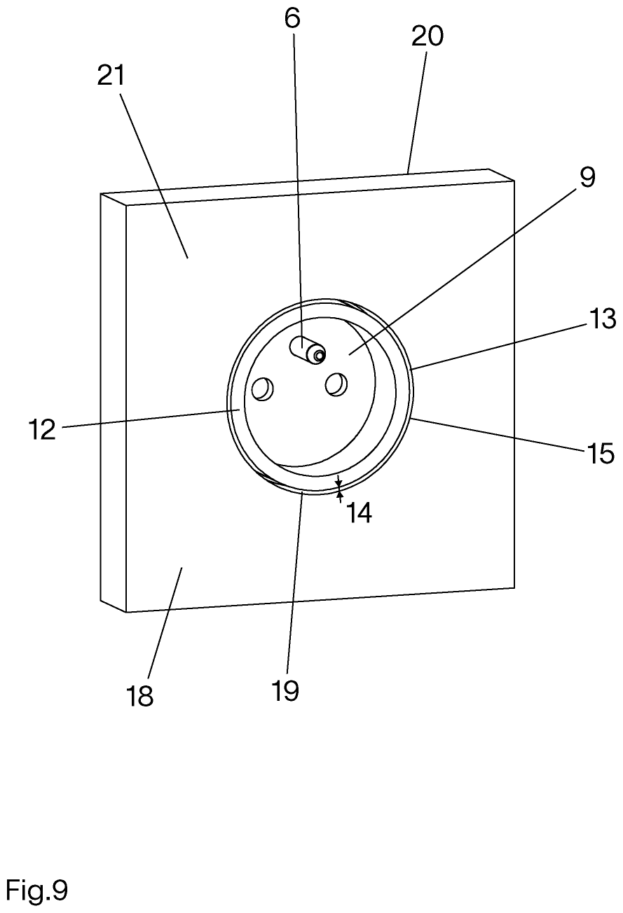

FIG. 9 shows a perspective view of a finished socket according to an alternative embodiment of the present invention.

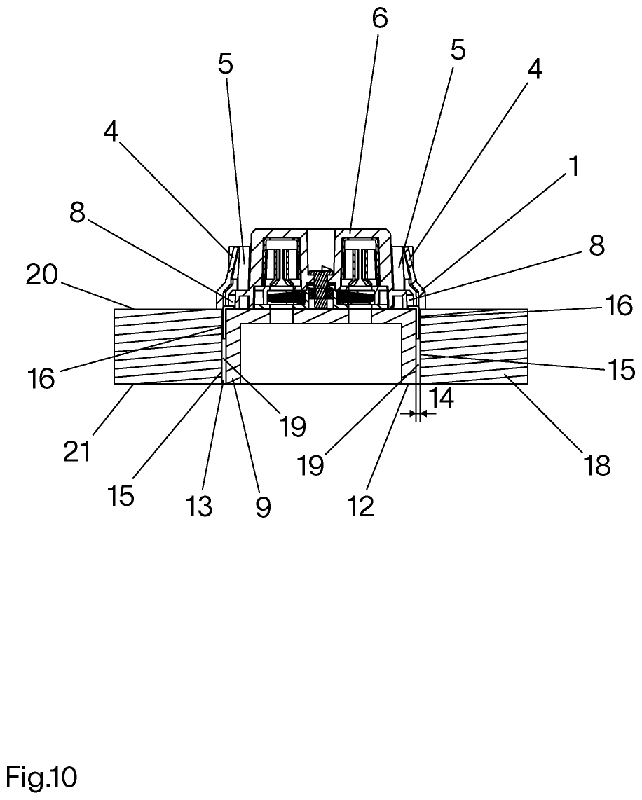

This embodiment is to a very large extent similar to the figures discussed previously. The point of difference is the specific design of the central part (9) and the filler element (16). The filler element in this case is a recessed filler element (16) and is therefore not visible. In this alternative embodiment, a minimal gap (13) is visible between the continuous side wall (15) of the passage (19) and the central part (9). The central part (9) is placed loosely on the electrical base element (6) and is clamped in the gap (13) by the recessed filler element (16). This is clear in FIG. 10.

FIG. 10 shows a cross-section of a finished socket according to an alternative embodiment of the present invention.

This embodiment corresponds to the embodiment of FIG. 9. The filler element (16) is made of a flexible and compressible material such as synthetic rubber. The filler element (16) is a cylindrical shape that fits around the central part (9). By loosely placing the central part (9) in the gap (13), the filler element (16) is compressed and the central part (9) is clamped in the gap. This embodiment is particularly advantageous in combination with a central part (9) made of a material that is not suitable for the use of, for example, click systems, screws or magnets, such as natural stone, ceramics, glass, etc. Clamping the central part (9) by the filler element (16) prevents the central part (9) from having to be further processed, which could cause these central parts (9) to crack or break. This embodiment is extremely advantageous for the flat and virtually invisible placement of an electrical base element (6) in board material (18) made of, for example, natural stone, ceramic, glass and similar materials, by providing a central part (9) made of the same material.

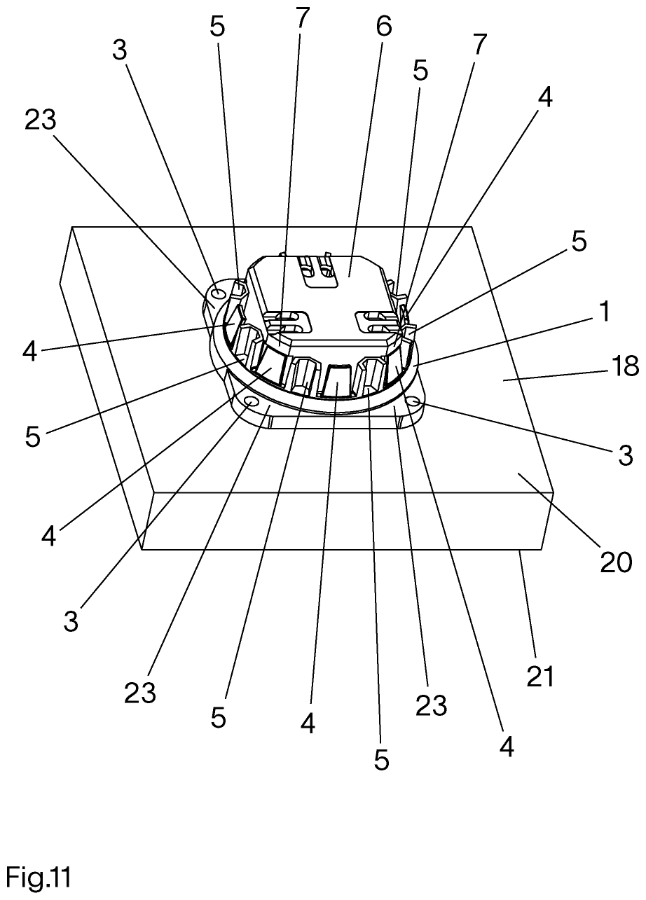

FIG. 11 shows a perspective view from another direction of a finished socket according to an embodiment of the present invention.

FIG. 11 applies to all previous figures. It is clearly visible how the mounting surface (13) rests against the rear side (20) of the board material (18).

The numbered elements in the figures are:
1. Flush-mounted box
2. Opening
3. Screw hole
4. Flexible arm
5. Stop
6. Electrical base element
7. Cam
8. Edge
9. Central part
10. Protrusion
11. Slot
12. Front surface of central part
13. Gap
14. Distance
15. Side wall
16. Filler element
17. Annular coil spring
18. Board material
19. Passage
20. Rear side
21. Front side
22. Front surface of filler element
23. Mounting surface

1. A method for flush mounting switches and sockets in board material, comprising:
making a passage for an electrical base element in the board material;
placing a flush-mounted box with an opening on a rear side of the board material, wherein the opening of the flush-mounted box is located at the passage; and
placing the electrical base element through the passage in the flush-mounted box, wherein a central part is placed on the electrical base element, wherein the central part covers the electrical base element, wherein a front surface of the central part is in the passage or in a plane formed by a front side of the board material and where the electrical base element is removably clicked into the flush-mounted box;
characterized in that there is a gap between the central part and each side wall of the passage, wherein there is a distance of at least 0.8 mm and a maximum of 10 mm in the plane formed by the front side of the board material between each side wall of the passage and the central part and in that after placing the electrical base element in the flush-mounted box, a filler element is removably placed in the gap, wherein the gap is filled over an entire distance by the filler element at at least one point between each side wall and the central part and at at least three points between a continuous side wall and the central part.

2. The method according to claim 1, characterized in that the gap in a plane parallel to the plane formed by the front side of the board material along an outline formed by all side walls of the passage in said plane is filled by the filler element over an entire distance between the central part and each side wall of the passage.

3. The method according to claim 1, characterized in that a front surface of the filler element is located in the plane formed by the front side of the board material.

4. The method according to claim 1, characterized in that the central part is attached to the electrical base element before placing the electrical base element.

5. The method according to claim 1, characterized in that the central part is placed loosely on the electrical base element after placing the electrical base element in the flush-mounted box, wherein the central part is clamped in the passage by placing the filler element.

6. The method according to claim 1, characterized in that the filler element is clicked into place in the gap.

7. The method according to claim 1, characterized in that the filler element is clamped in the gap.

8. A kit for flush mounting of switches and sockets in board material, comprising a flush-mounted box, an electrical base element and a central part, wherein the flush-mounted box comprises an opening for placing the electrical base element in the flush-mounted box and a mounting surface for placing the flush-mounted box with the mounting surface on a rear side of the board material, wherein the opening of the flush-mounted box lies in the mounting surface, wherein the flush-mounted box comprises mounting means for removably attaching the electrical base element in the flush-mounted box, wherein the central part can be placed on the electrical base element, wherein the central part covers the electrical base element after mounting the electrical base element in the flush-mounted box and after placing the central part on the electrical base element, wherein a front surface of the central part is located outside the flush-mounted box, characterized in that the kit further comprises a filler element for filling a gap in a passage for the electrical base element in the board material, wherein the central part, after placement of the electrical base element in the flush-mounted box, after placement of the central part on the electrical base element and after placement of the filler element in the gap in the passage in the mounting surface of the flush-mounted box, has an outline, wherein the filler element fits the outline of the central part, wherein the filler element extends from the central part at at least one point of each side wall of the central part or at at least three points of a continuous side wall of the central part over a distance of at least 0.8 mm and wherein the filler element extends from the central part along the outline over a distance of at most 10 mm.

9. The kit according to claim 8, characterized in that the filler element extends from the central part along the outline over a distance of at least 0.8 mm.

10. The kit according to claim 8, characterized in that the filler element extends from the central part along the outline over an equal distance.

11. The kit according to claim 8, characterized in that the filler element comprises means for clamping the filler element in a passage in the board material.

12. The kit according to claim 8, characterized in that the filler element comprises means for clicking the filler element onto the central part.

13. The kit according to claim 8, characterized in that the filler element can be clamped to the central part.
